(19) United States
(12) Patent Application Publication
(10) Pub. No.: US 2011/0288777 A1
(43) Pub. Date: Nov. 24, 2011

(54) SYSTEM, DEVICE AND METHOD FOR AUTOMATIC DETECTION AND REPORTING OF LOCATION AND EXTENT OF SERVICE FAILURE IN UTILITY AND TELECOMMUNICATION NETWORKS

(76) Inventor: VARUN GUPTA, Nashua, NH (US)

(21) Appl. No.: 13/110,946

(22) Filed: May 19, 2011

Related U.S. Application Data
(60) Provisional application No. 61/346,046, filed on May 19, 2010.

(51) Int. Cl. G06F 19/00; G06F 15/00; G06Q 10/00

(52) U.S. Cl. 702/5; 705/7.13; 702/1; 702/57

(57) ABSTRACT

System, device and method for automatic detection and reporting of location and extent of service failure in utility and/or telecommunication networks are disclosed. In one embodiment, operational condition information of each utility pole/tower or telecommunication pole/tower is obtained by using a pole/tower sensing device disposed to monitor operational conditions at each utility pole/tower or telecommunication pole/tower in the respective utility or telecommunication networks. Further, the obtained operational condition information of each utility pole/tower or telecommunication pole/tower is sent to a remote monitoring server via a communication network by the associated pole/tower sensing device. Furthermore, the operational condition information received from each utility pole/tower or telecommunication pole/tower is processed by the remote monitoring server. Based on the outcome of processing the operational condition information by the remote monitoring server, location and extent of service failure in the utility or telecommunication networks is reported.

This application claims priority under 35 U.S.C. 119(e) to US Provisional Application No. 61346046 entitled “Method and apparatus for automatic detection and reporting of location and extent of disruption in utility networks” by Varun Gupta filed on May 19, 2010, which is incorporated herein by reference.

### TECHNICAL FIELD

The present invention relates generally to utility networks, and more particularly to remote monitoring of utility grids.

### BACKGROUND

Utility networks, such as electrical grids, telecommunication/phone networks and the like are an integral part of our modern life. Services provided by the utility networks are indispensable in all sectors of our society. Loss of electricity, as a result of a power outage or loss of telephone communication and broadband not only can cause considerable disruption and inconvenience in our daily lives, but also can cause significant economic loss due to reduced industrial productivity and economic activity. Our society today, demands uninterrupted and reliable service from the public utilities and telecommunications service providers to carry out the daily activities. Loss of electricity and telecommunication services can also cause significant revenue loss to the public utilities and telecommunications service providers.

Typically, utility and telecommunication networks are built using massive infrastructure, including poles, wires and network assets, such as transformers, reclosers for electrical network, remote telecommunication devices for the phone network, and the like, which physically provide a mechanism to deliver the services to the end users. Very often, such infrastructure is located in remote, inaccessible, difficult to reach places. Natural calamities, such as storms, hurricanes, snow-covered limbs and so on and man-made events, such as a car or a truck colliding with electric and transmission poles can cause significant damage to the infrastructure built by the utility and telecommunication networks.

Today, at any given time, the utility companies have no detailed visibility of the condition of their network infrastructure. Existing techniques, do not provide the utility companies with the needed granular information so that they can determine when and where the events and calamities have occurred and the extent and type of problem, immediately, when a fault occurs in their network. In the absence of such information, utility crews are physically sent to first survey a general area and report back any found problem to a central location, which enables the central office to send the needed crew to fix the problem. Sometimes, while fixing one problem other potential problems may be uncovered in the utility and telecommunication networks which were not discovered during the survey as they may not be easily visible or ascertainable. Such situations can lead to requiring more time and resources to resolve the problems encountered at the utility and telecommunication networks and provide the needed essential services our modern society demands.

One existing most frequently used approach to resolve such problems depends on manual reporting of power or telecommunication outage by a nearby home or business owner/consumer by a phone, if they can get to a working phone, or filling up a form via a utility website. The biggest disadvantage of this current approach is that, in such situations, the service provider may not know the severity and/or extent of the problem. Also, in such situations the utility company may not know if the problem is localized to one electric/telecommunication pole or several electric/telecommunication poles. Further, with the manual approach, the utility and/or the telecommunication companies are completely dependent on the owner/consumer to report the power outage and then send the crew to survey the extent of damage and report to a central location to dispatch the needed resources to resolve the problem. Furthermore, at times, one problem can mask other downstream problems making it difficult to quickly resolve the problems and to timely resume the needed services.

Currently, there are no mechanisms that automatically provide the required detailed information associated with the extent and type of damage to the infrastructure to the utility networks so that they can attend to the problem and resolve it timely. Current power systems or telecommunication technologies may provide some information if there is a widespread outage, however, they do not have any mechanism to provide the required detailed information in a precise manner to resolve the problem quickly so that the services can be resumed without significant delay.

### SUMMARY

System, device and method for automatic detection and reporting of location and extent of service failure in utility and telecommunication networks are disclosed. According to one aspect of the present invention, operational condition information of each utility pole/tower or telecommunication pole/tower is obtained by using a pole/tower sensing device disposed to monitor operational conditions at each utility pole/tower or telecommunication pole/tower in the respective utility or telecommunication networks. Further, the obtained operational condition information of each utility pole/tower or telecommunication pole/tower is sent to a remote monitoring server via a communication network by the associated pole/tower sensing device. Furthermore, an acknowledgement of receipt of the received operational condition information from a respective pole/tower sensing device is sent by the remote monitoring server upon receiving the operational condition information from each associated pole/tower sensing device.

In addition in this embodiment, the operational condition information received from each utility pole/tower or telecommunication pole/tower is processed by the remote monitoring server. Based on the outcome of processing the operational condition information by the remote monitoring server, location and extent of service failure in the utility or telecommunication networks is reported. In addition, utility or telecommunication network crew is deployed to the reported location to restore the service.

According to another aspect of the present invention, the system includes a plurality of utility poles/towers and/or telecommunication poles/towers, a pole/tower sensing device disposed on each of the plurality of utility poles/towers and/or telecommunication poles/towers to monitor the operational conditions at each utility pole/tower or telecommunication pole/tower in the respective utility or telecommunication networks and a remote monitoring server coupled to each pole/tower sensing device via a communication network. In one embodiment, operational condition information is obtained by the pole/tower sensing device of each utility pole/tower or telecommunication pole/tower. Further, the obtained operational condition information of each utility pole/tower or telecommunication pole/tower is sent by the pole/tower sensing device to the remote monitoring server via the communication network. Furthermore, the operational condition information received from each utility pole/tower or telecommunication pole/tower is processed by the remote monitoring server. In addition, based on the outcome of processing the operational condition information, location and extent of service failure in the utility or telecommunication networks is reported by the remote monitoring server for deploying utility and/or telecommunication network crews to the reported location to restore the service.

The system and methods disclosed herein may be implemented in any means for achieving various aspects, and other features will be apparent from the accompanying drawings and from the detailed description that follows.

### BRIEF DESCRIPTION OF THE DRAWINGS

Various embodiments are described herein with reference to the drawings, wherein:

FIG. 1 is a block diagram illustrating major elements of utility and/or telecommunication networks for automatic detection and reporting of location and extent of service failure, according to an embodiment of the invention;

FIG. 2 is a block diagram illustrating major elements included in pole/tower sensing devices used in the utility and/or telecommunication networks, such as those shown in FIG. 1, according to an embodiment of the invention;

FIG. 3 is a state diagram illustrating various states of the pole/tower sensing devices, such as those shown in FIG. 1, according to an embodiment of the invention;

FIG. 4 is a block diagram illustrating the utility and/or telecommunication networks of FIG. 1 when in operation, according to an embodiment of the invention;

FIG. 5 is another block diagram illustrating the utility and/or telecommunication networks of FIG. 1 when in operation, according to an embodiment of the invention;

FIG. 6 illustrates an exemplary screenshot of an initial user-interface (UI) screen displayed on a display device during operation of the utility and/or telecommunication networks of FIG. 1;

FIG. 7 illustrates an exemplary screenshot of an activity log of one of the nodes, displayed on the display device, during operation of the utility and/or telecommunication networks of FIG. 1;

FIG. 8 is an exemplary screenshot, displayed on the display device, showing current sensor values of an associated pole/tower as sensed by sensors in the associated one of the nodes, during operation of the utility and/or telecommunication networks of FIG. 1;

FIG. 9 is an exemplary screenshot, displayed on the display device, showing parameter values associated with the sensors in one of the nodes, during operation of the utility and/or telecommunication networks of FIG. 1;

FIG. 10 illustrates a flow diagram of a method for automatic detection and reporting of location and extent of service failure in the utility and/or telecommunication networks, such as those shown in FIG. 1, according to an embodiment of the invention;

FIG. 11 illustrates another flow diagram of a method for automatic detection and reporting of location and extent of service failure in the utility and/or telecommunication networks, such as those shown in FIG. 1, according to an embodiment of the invention; and

FIG. 12 illustrates yet another flow diagram of a method for automatic detection and reporting of location and extent of service failure in the utility and/or telecommunication networks, such as those shown in FIG. 1, according to an embodiment of the invention.

The drawings described herein are for illustration purposes only and are not intended to limit the scope of the present invention in any way.

### DETAILED DESCRIPTION

System, device and method for automatic detection and reporting of location and extent of service failure in utility and telecommunication networks are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The terms “pole/tower sensing device” and “node” are used interchangeably throughout the document.

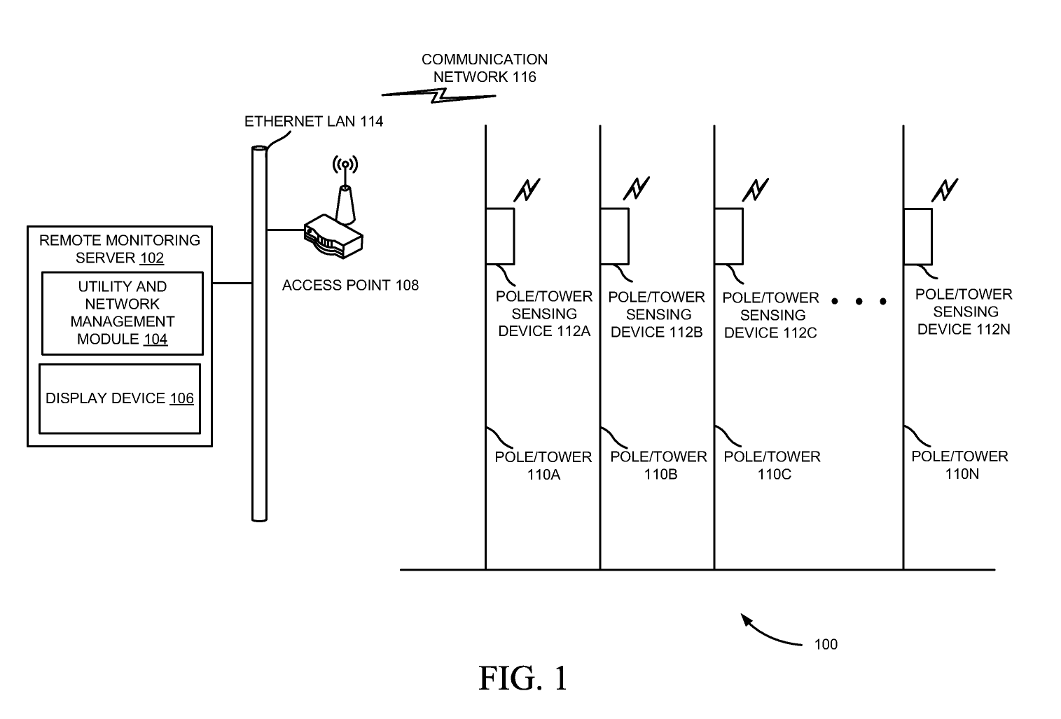

FIG. 1 is a block diagram illustrating major elements of utility and/or telecommunication networks for automatic detection and reporting of location and extent of service failure, according to an embodiment of the invention. Particularly, FIG. 1 illustrates a utility or telecommunication network 100 including a remote monitoring server 102, an access point 108 and a plurality of poles/towers 110A-N. Exemplary poles/towers 110A-N include a plurality of utility poles and a plurality of telecommunication poles in the respective utility and telecommunication networks, a plurality of transmission towers and the like. Further as shown in FIG. 1, the remote monitoring server 102 includes a utility and network management module 104 and a display device 106. Furthermore as shown in FIG. 1, the remote monitoring server 102 is coupled to the access point 108 via an Ethernet local area network (LAN) 114. One can also envision coupling the access point 108 to the remote monitoring server 102 via a cell/satellite modem.

In one embodiment, pole/tower sensing devices 112A-N are disposed on each of the poles/towers 110A-N, as shown in FIG. 1. For example, the pole/tower sensing devices 112A-N can be attached at a central height on the poles/towers 110A-N. In addition as shown in FIG. 1, each of the pole/tower sensing devices 112A-N is coupled to the remote monitoring server 102 via a communication network 116. Exemplary communication network 116 includes a wireless communication network, a satellite communication network, a cellular communication network, a radio communication network, a 2 way pager communication network, a cell/satellite modem, an Ethernet network and the like. Also as shown in FIG. 1, each of the pole/tower sensing devices 112A-N is coupled to the remote monitoring server 102 via the communication network 116 through the access point 108.

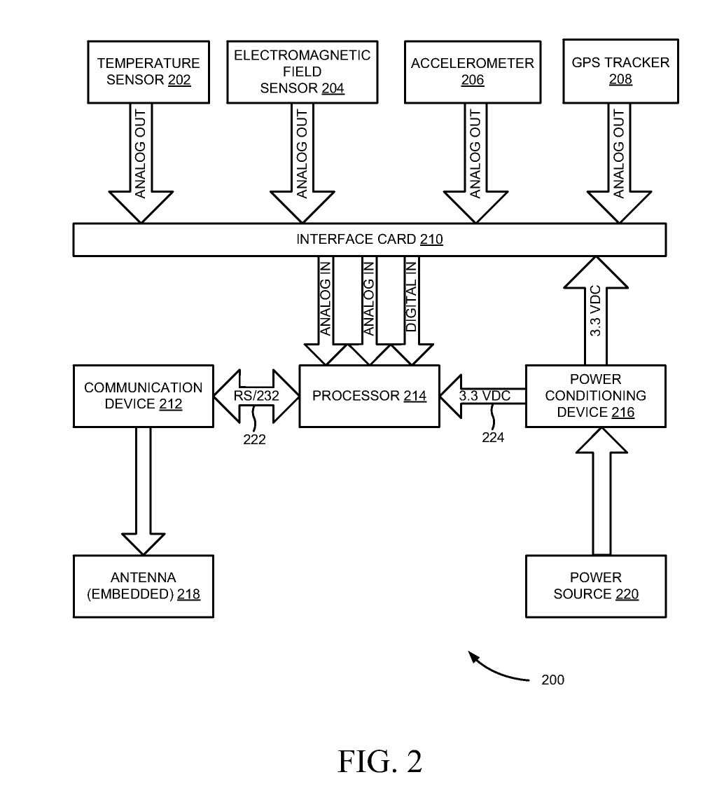

In operation, each of the pole/tower sensing devices 112A-N obtains operational condition information of the respective poles/towers 110A-N. Exemplary operational conditions include temperature, position, vibration, electromagnetic field (EMF) and the like. This is explained in more detail with reference to FIG. 2. Further in operation, each of the pole/tower sensing devices 112A-N determines whether each of the obtained temperature, position, vibration and EMF values are substantially above, equal to or below an associated threshold value. Based on the outcome of the determination, each of the pole/tower sensing devices 112A-N sends the obtained operational condition information of the respective poles/towers 110A-N to the remote monitoring server 102 via the communication network 116. In one embodiment, each of the pole/tower sensing devices 112A-N sends the obtained operational condition information along with a unique identification (ID) associated with each of the poles/towers 110A-N. In this embodiment, each of the pole/tower sensing devices 112A-N is assigned with an IP address by an administrator using the remote monitoring server 102. Further in this embodiment, the obtained operational condition information is sent to the remote monitoring server 102 via the access point 108. Typically, the access point 108 manages and maintains communication with the pole/tower sensing devices 112A-N using a standard communication protocol.

Furthermore in operation, the utility and network management module 104 residing in the remote monitoring server 102 sends an acknowledgement of receipt of the received operational condition information to the respective pole/tower sensing devices 112A-N upon receiving the operational condition information from each associated pole/tower sensing devices 112A-N.

In addition in operation, the remote monitoring server 102 processes the operational condition information received from each of the poles/towers 110A-N to determine the location and extent of service failure in any utility and/or telecommunication networks. Based on the outcome of the determination, the remote monitoring server 102 reports the location and extent of service failure in the utility and/or telecommunication networks.

Also in operation, the utility and network management module 104 in the remote monitoring server 102 ensures accuracy of the location information obtained from the pole/tower sensing devices 112A-N. In addition, the utility and network management module 104 displays the obtained location information in the form of a map, using a geographic information system (GIS) system, on the display device 106 in the remote monitoring server 102.

In an exemplary scenario, if the operational conditions of several poles/towers are above the associated threshold values, then pole/tower sensing devices associated with each of the disrupted poles/towers send operational condition information to the remote monitoring server 102. This facilitates in deploying sufficient and precise number of utility and/or telecommunication network crews to the reported location, based on the location and extent of service failure reported by the remote monitoring server 102, to restore the service.

Referring now to FIG. 2, a block diagram 200 illustrates major elements included in each of the pole/tower sensing devices 112A-N used in the utility and/or telecommunication network 100, such as those shown in FIG. 1, according to an embodiment of the invention. As shown in FIG. 2, each of the pole/tower sensing devices 112A-N includes a plurality of sensors, such as a temperature sensor 202, an EMF sensor 204, an accelerometer 206 and a global positioning system (GPS) tracker 208 coupled to a processor 214 via an interface card 210. Further as shown in FIG. 2, each of the pole/tower sensing devices 112A-N includes a communication device 212, an antenna (embedded) 218, a power source 220 and an associated power conditioning device 216. Furthermore as shown in FIG. 2, the power source 220 is coupled to the processor 214 via the power conditioning device 216. Also as shown in FIG. 2, the communication device 212 is coupled to the processor 214. In addition as shown in FIG. 2, the antenna (embedded) 218 is coupled to the processor 214 via the communication device 212.

In one embodiment, each of the pole/tower sensing devices 112A-N monitors the operational conditions of an associated one of the poles/towers 110A-N, shown in FIG. 1. In this embodiment, the operational condition information associated with each of the poles/towers 110A-N is obtained by the associated pole/tower sensing devices 112A-N using the temperature sensor 202, the EMF sensor 204, the accelerometer 206 and the GPS tracker 208. For example, the operational condition information can be obtained at predetermined intervals of time.

In operation, the processor 214, determines whether each of the sensed temperature, position, vibration and EMF values are substantially above, equal to or below the associated threshold values. In one example embodiment, the threshold value associated with each operational condition is programmable by a user using the utility and network management module 104 residing in the remote monitoring server 102.

Further in operation, the temperature sensor 202 in each of the pole/tower sensing devices 112A-N obtains a temperature substantially in and around the associated one of the poles/towers 110A-N. For example, the temperature value can be obtained in degrees centigrade or Fahrenheit. In one embodiment, the obtained temperature value is sent to the processor 214 via the interface card 210. Further, the processor 214 determines whether the obtained temperature value is above, equal to, or below the associated threshold value. If the obtained temperature value is above the associated threshold value, a notification indicating the rise in temperature is sent to the remote monitoring server 102, shown in FIG. 1. In an exemplary scenario, a sudden increase in temperature in or around one of the poles/towers 110A-N can indicate an electric fire which may be caused due to downed and/or disturbed power lines in the one of the poles/towers 110A-N. In this scenario, a notification indicating the electric fire is sent, by the associated one of the pole/tower sensing devices 112A-N, to the remote monitoring server 102, shown in FIG. 1.

Furthermore in operation, the EMF sensor 204 in each of the pole/tower sensing devices 112A-N senses the presence or absence of current flow in and around the associated one of the poles/towers 110A-N. For example, the EMF sensor 204 can include a pickup coil, an amplifier and a current to voltage converter. The voltage measured by the EMF sensor 204 in each of the pole/tower sensing devices 112A-N indicates the presence or absence of current flow in the associated one of the poles/towers 110A-N. In one example embodiment, the EMF sensor 204 is configured to provide a reading of about 1 if the current is flowing and a reading of about 0 if the current is not flowing. Based on the presence or absence of current flow in the associated one of the poles/towers 110A-N, a corresponding notification is sent, by each of the pole/tower sensing devices 112A-N, to the remote monitoring server 102, shown in FIG. 1. In an exemplary scenario, absence of current flow in one of the poles/towers 110 A-N may indicate that a power line in the associated one of the poles/towers 110A-N has snapped.

In addition in operation, the accelerometer 206 in each of the pole/tower sensing devices 112A-N obtains position information and senses any vibration in the associated one of the poles/towers 110A-N. In one embodiment, the position information obtained from the accelerometer 206 indicates any inclination/tilt in the associated one of the poles/towers 110A-N from the normal position. For example, the position information can include X, Y and Z axis information of the associated one of poles/towers 110A-N. Further in this embodiment, the accelerometer 206 is configured to obtain the position information periodically so that any positional change from the previously obtained position information can be determined. Furthermore, the obtained position information is sent to the processor 214 via the interface card 210. The processor 214 evaluates the obtained position information to determine any change in inclination/tilt in the associated one of the poles/towers 110A-N.

Also, any change in position in the associated one of the poles/towers 110A-N detected by the processor 214 is evaluated to determine whether the detected change in position is within the threshold value associated with the position of the associated one of the poles/towers 110A-N. If the change in position is above the associated threshold value, a corresponding notification indicating the inclination/tilt is sent to the remote monitoring server 102, shown in FIG. 1. However, using this approach, it may be difficult to distinguish between a partially fallen and a completely fallen position of the associated one of the poles/towers 110A-N. In another embodiment, the accelerometer 206 in each of the pole/tower sensing devices 112A-N senses any vibration in the associated one of the poles/towers 110A-N.

In an exemplary scenario, when an inclination/tilt is detected in the associated one of the poles/towers 110A-N, the processor 214 continuously acquires and processes the position information received from the accelerometer 206 until the motion/inclination stops. Further, the processor 214 evaluates the detected change in position and also senses any vibration detected in the associated one of the poles/towers 110A-N. Typically, a large amount of vibration indicates an imminent impact of the associated one of the poles/towers 110A-N on the ground and can be used to distinguish between a partially fallen and a completely fallen position of the associated one of the poles/towers 110A-N.

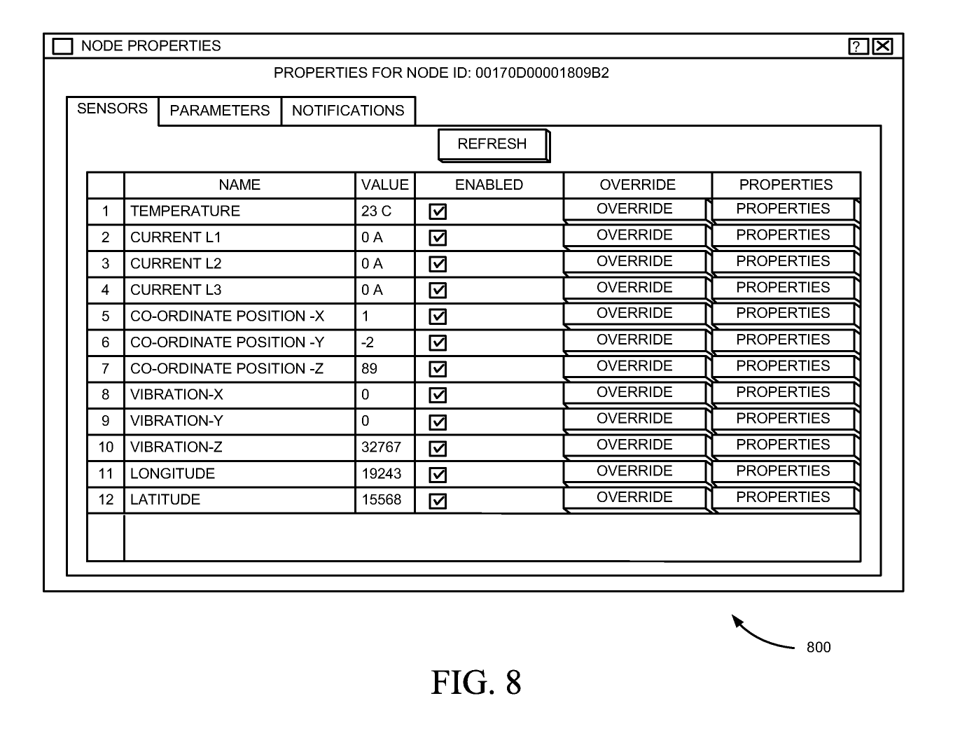

Moreover in operation, the GPS tracker 208 in each of the pole/tower sensing devices 112A-N obtains location information of the associated one of the poles/towers 110A-N. In one embodiment, during an initial setup of each of the pole/tower sensing devices 112A-N on the associated one of the poles/towers 110A-N, the position co-ordinate information of the associated one of the poles/towers 110A-N is determined by the GPS tracker 208. The obtained position co-ordinate information is saved as part of the properties of the associated one of the pole/tower sensing devices 112A-N in the remote monitoring server 102, shown in FIG. 1. This is explained in more detail with reference to FIG. 8. Further, the utility and network management module 104 in the remote monitoring server 102, shown in FIG. 1, ensures the accuracy of the location information obtained from the GPS tracker 208. Furthermore, the utility and network management module 104 displays the obtained location information in the form of a map, using the GIS system, on the display device 106 coupled to the remote monitoring server 102, shown in FIG. 1. For example, the position co-ordinates can be used to determine partially fallen or completely fallen position of the associated one of the poles/towers 110A-N.

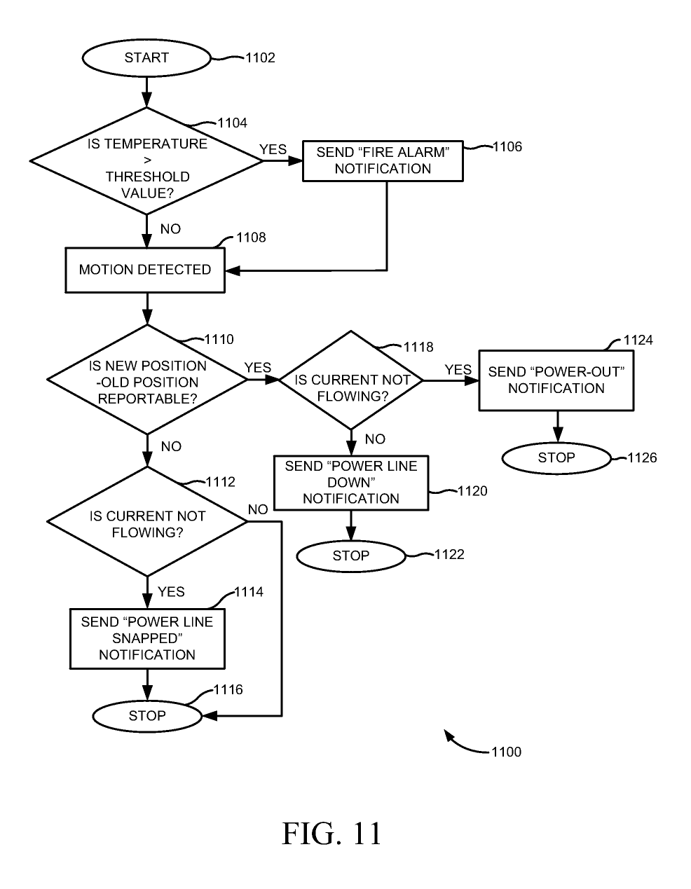

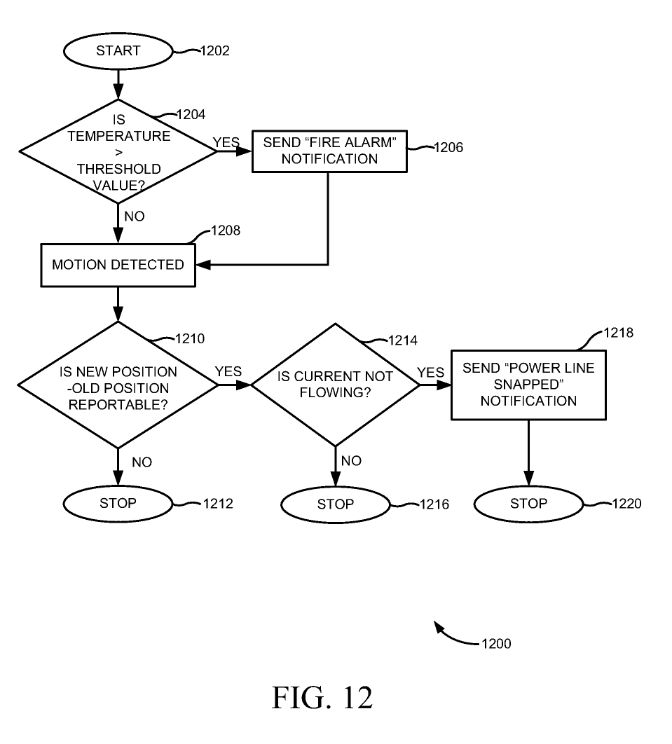

In this embodiment, if the operational condition information obtained from any of the sensors in each of the pole/tower sensing devices 112A-N is above the associated threshold value, a corresponding notification along with the obtained operational condition information is sent to the remote monitoring server 102, shown in FIG. 1. This is explained in more detail with reference to FIGS. 11 and 12. Further in this embodiment, the notifications are sent by any of the pole/tower sensing devices 112A-N using the communication device 212, shown in FIG. 2. Exemplary communication device 212 includes a radio frequency (RF) module and the like. The communication device 212 transmits the notifications obtained from the processor 214 to the remote monitoring server 102 via the antenna (embedded) 218.

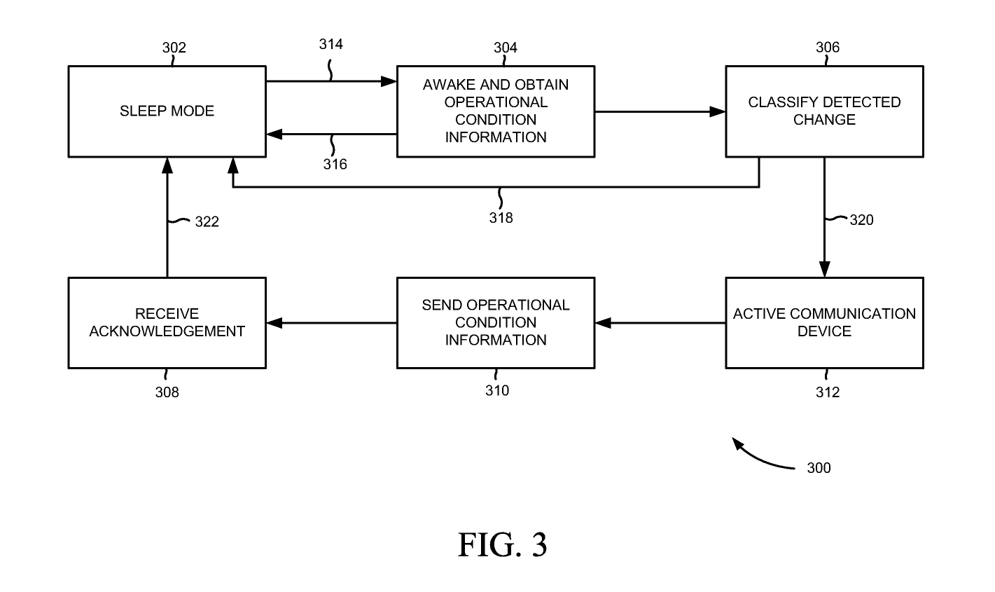

Furthermore in this embodiment, the power source 220, in each of the pole/tower sensing devices 112A-N, supplies power to the processor 214 and the sensors via the power conditioning device 216. For example, the power source 220 includes a battery and an AC power source. In order to conserve battery power, each of the pole/tower sensing devices 112A-N is configured to go into a sleep mode and further configured to wake up when required to send the operational condition information and/or notifications to the remote monitoring server 102, shown in FIG. 1. This is explained in more detail with reference to FIG. 3. In some embodiments, each of the pole/tower sensing devices 112A-N is configured to scavenge energy from the surrounding environment. For example, the energy can be scavenged from sources, such as solar energy, wind energy, EMF and the like.

Referring now to FIG. 3, a state diagram 300 illustrates various states of each of the pole/tower sensing devices 112A-N, such as the one shown in FIG. 1, according to an embodiment of the invention. In one embodiment, state 302 is considered as an initial state of each of the pole/tower sensing devices 112A-N. In the state 302, each of the pole/tower sensing devices 112A-N, shown in FIG. 1, is in sleep mode. In the sleep mode, each of the pole/tower sensing devices 112A-N is configured to operate in a low power state in order to conserve battery power. Further in the sleep mode, each of the pole/tower sensing devices 112A-N continues to monitor the operational conditions of the associated one of the poles/towers 110A-N, however, no information is sent to the remote monitoring server 102, shown in FIG. 1. Furthermore, any change, in any of the operational conditions, detected by any of the pole/tower sensing devices 112A-N, results in a transition from the state 302 to state 304. This is indicated by transition 314. Exemplary change in the operational condition includes movement and/or temperature change in the associated one of the poles/towers 110A-N.

In the state 304, each of the pole/tower sensing devices 112A-N wakes up and the processor 214, shown in FIG. 2, in each of the pole/tower sensing devices 112A-N, obtains the operational condition information of the associated one of the poles/towers 110A-N, from the sensors in each of the pole/tower sensing devices 112A-N, shown in FIG. 2. In one example embodiment, a timeout value may be associated with each of the pole/tower sensing devices 112A-N for obtaining the operational condition information of the associated one of the poles/towers 110A-N. If the operational condition information of any one of the poles/towers 110A-N is not obtained within the timeout value, then the associated one of the pole/tower sensing devices 112A-N returns to the sleep mode in the state 302. This is indicated by transition 316. Obtaining the operational condition information within the timeout value results in a transition from the state 304 to state 306.

In state 306, the obtained operational condition information and the detected changes are classified by the processor 214 in each of the pole/tower sensing devices 112A-N. Further in the state 306, it is determined whether the obtained operational condition information and the detected changes are above, equal to or below the associated threshold values. If the obtained operational condition information and the detected changes are above the associated threshold values, then the detected changes are reported to the remote monitoring server 102, resulting in a transition from the state 306 to state 312. This is indicated by transition 320. In the state 312, the communication device 212, shown in FIG. 2, in each of the pole/tower sensing devices 112A-N is activated to transmit the obtained operational condition information and corresponding notifications to the remote monitoring server 102, shown in FIG. 1, based on the detected changes. This is explained in more detail with reference to FIG. 2.

In state 310, the operational condition information and the corresponding notifications are sent to the remote monitoring server 102, shown in FIG. 1, by the communication device 212 via the antenna (embedded) 218, shown in FIG. 2. In state 308, each of the pole/tower sensing devices 112A-N receives acknowledgement from the utility and network management module 104 in the remote monitoring device 102, shown in FIG. 1, for receiving the operational condition information and the corresponding notifications. After the acknowledgement is received in the state 308, each of the pole/tower sensing devices 112A-N returns to the sleep mode in the state 302. This is indicated by transition 322.

Referring back to the state 306, if it is determined that the operational condition information and the detected changes are not above the associated threshold values, then the detected changes are not reported to the remote monitoring server 102, resulting in a transition from the state 306 to the state 302. This is indicated by transition 318. Further, each of the pole/tower sensing devices 112A-N returns to the sleep mode in the state 302.

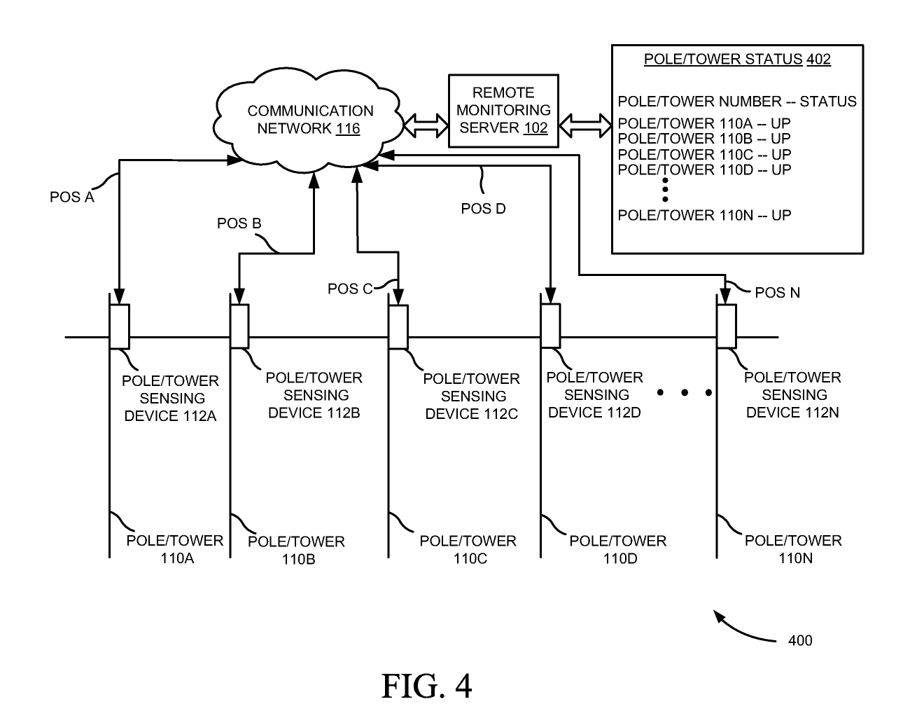

Referring now to FIG. 4, a block diagram 400 illustrates the utility and/or telecommunication network 100 of FIG. 1 when in operation, according to an embodiment of the invention. Particularly, FIG. 4 illustrates pole/tower status 402 of the poles/towers 110A-N determined based on position information POS A-N obtained from the poles/towers 110A-N, respectively. In one embodiment, the status of a pole/tower is indicated as ‘UP’ when the pole/tower is in a normal position and the status of a pole/tower is indicated as ‘DOWN’ when the pole/tower is in a partially fallen or a completely fallen position.

In operation, the position information POS A-N of the poles/towers 110A-N, respectively, are obtained from the associated pole/tower sensing devices 112A-N. In one embodiment, the accelerometer 206 in each of the pole/tower sensing devices 112A-N measures the position information of the associated poles/towers 110A-N. This is explained in more detail with reference to FIG. 2. Further in operation, the obtained position information POS A-N of the poles/towers 110A-N, respectively, are sent to the remote monitoring server 102 via the communication network 116. Furthermore in operation, based on the position information POS A-N obtained from the poles/towers 110A-N, respectively, the remote monitoring server 102 determines the pole/tower status 402 of each of the poles/towers 110A-N. As shown in FIG. 4, each of the poles/towers 110A-N is in the normal condition. Therefore, the status of each of the poles/towers 110A-N is indicated as UP.

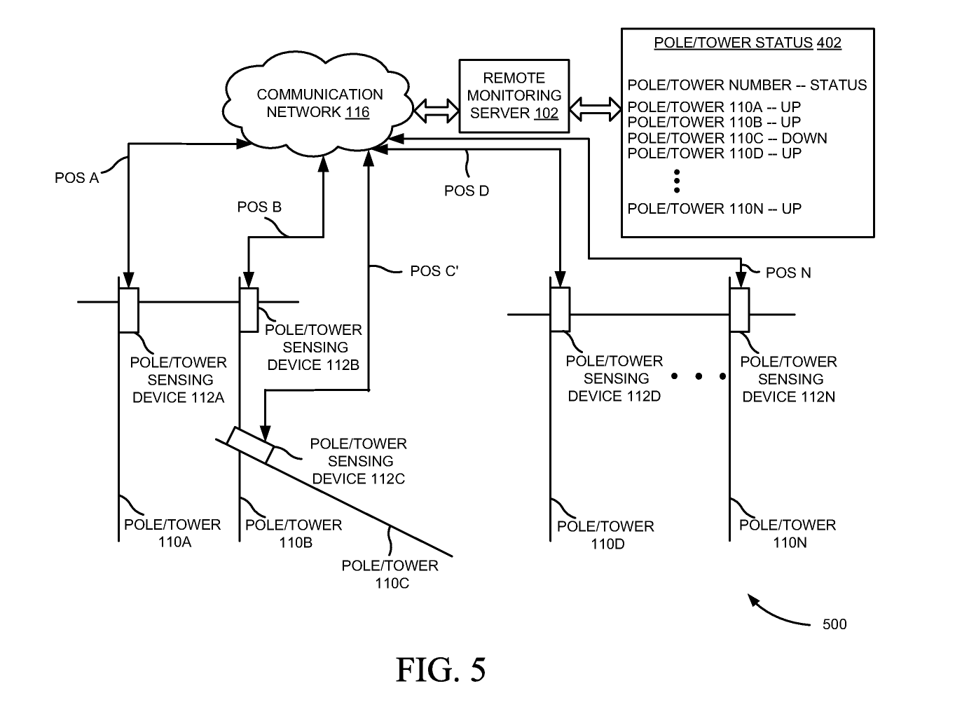

Referring now to FIG. 5, another block diagram 500 illustrates the utility and/or telecommunication network 100 of FIG. 1 when in operation, according to another embodiment of the invention. The block diagram 500, shown in FIG. 5, is similar to the block diagram 400, shown in FIG. 4, except that the block diagram 500 illustrates an exemplary scenario where one of the poles/towers 110A-N is inclined/tilted. Further, similar to FIG. 4, the status of a pole/tower is indicated as ‘UP’ when the pole/tower is in a normal position and the status of a pole/tower is indicated as ‘DOWN’ when the pole/tower is in a partially fallen or a completely fallen position.

As shown in FIG. 5, the pole/tower 110C is inclined/tilted and the new position information POS C′ associated with the pole/tower 110C is sent to the remote monitoring server 102 via the communication network 116. In operation, the new position information POS C′ is processed by a processor in the pole/tower sensing device 112C associated with the pole/tower 110C. This is explained in more detail with reference to FIG. 2. If the obtained new position information POS C′ is above the threshold value associated with the position of the pole/tower 110C, the new position information POS C′ and a corresponding notification are sent by the pole/tower sensing device 112C to the remote monitoring server 102. This is explained in more detail with reference to FIGS. 11 and 12. Based on the received new position information POS C′ and the corresponding notification, the remote monitoring server 102 updates the pole/tower status 402 of pole/tower 110C as DOWN, as shown in FIG. 5. Also, the remote monitoring server 102 sends back an acknowledgement of receipt of the new position information POS C′ and the notification to the pole/tower sensing device 112C.

In an exemplary scenario, a notification is sent to the remote monitoring server 102, by the pole/tower sensing device 112C, indicating that the new position information POS C′ associated with the pole/tower 110C is above the associated threshold value. Using the obtained new position information POS C′ and the notification, the remote monitoring server 102 determines whether the pole/tower 110C is in a partially fallen or a completely fallen position. Further, another notification is sent to the remote monitoring server 102, by the pole/tower sensing device 112C, indicating that current is not flowing in the pole/tower 110C. In this scenario, the remote monitoring server 102 receives the two notifications separately and identifies the combined condition of the pole/tower 110C.

In the above exemplary scenario, if there is no notification regarding absence of current flow in the pole/tower sensing device 112C, then it implies normal current flow in the pole/tower sensing device 112C.

Further in the above exemplary scenario, if the pole/tower 110C is on a hill, the inclination/tilt of the pole/tower 110C required for the pole/tower 110C to be in a completely fallen position will be different from the inclination/tilt required for the pole/tower 110C to be in a completely fallen position when it is on a flat surface. This is determined using the terrain information associated with the pole/tower 110C which is obtained during the installation of the pole/tower 110C. Using the terrain information and the obtained new position information POS C′, the remote monitoring server 102 determines whether the pole/tower 110C is in a partially fallen or a completely fallen position.

Furthermore in the above exemplary scenario, location information associated with the pole/tower 110C is obtained using a GPS tracker in the pole/tower sensing device 112C. This is explained in more detail with reference to FIG. 2. The obtained location information associated with the pole/tower 110C is used, by the remote monitoring server 102, to determine whether the pole/tower 110C is near a road. Furthermore, based on the obtained location information and the new position information POS C′, the remote monitoring server 102 determines whether the pole/tower 110C is blocking the road.

In another exemplary scenario, multiple poles/towers may be in a partially fallen and/or completely fallen position. In this scenario, position information and notifications from each of the poles/towers indicating the inclination/tilt exceeding the associated threshold value are sent to the remote monitoring server 102. Further, based on the position information and the notification obtained from each of the poles/towers, the remote monitoring server 102 determines whether each of the poles/towers is in a partially fallen or completely fallen position.

In yet another exemplary scenario, an object, such as a tree limb may have fallen on a power line in a pole/tower. Further, current may still be flowing through the power line in the pole/tower. In this scenario, the vibrations in the pole/tower will be sensed by an accelerometer in the associated pole/tower sensing device. Using the vibration information and the position information of the associated pole/tower, the remote monitoring server 102 determines the condition of the associated pole/tower.

In all the above scenarios, after the operational conditions of a disrupted pole/tower are corrected, by the utility and/or telecommunication crews, a notification indicating that the disrupted pole/tower is in normal condition is sent, by the pole/tower sensing device 112C, to the remote monitoring server 102 to update the pole/tower status 402.

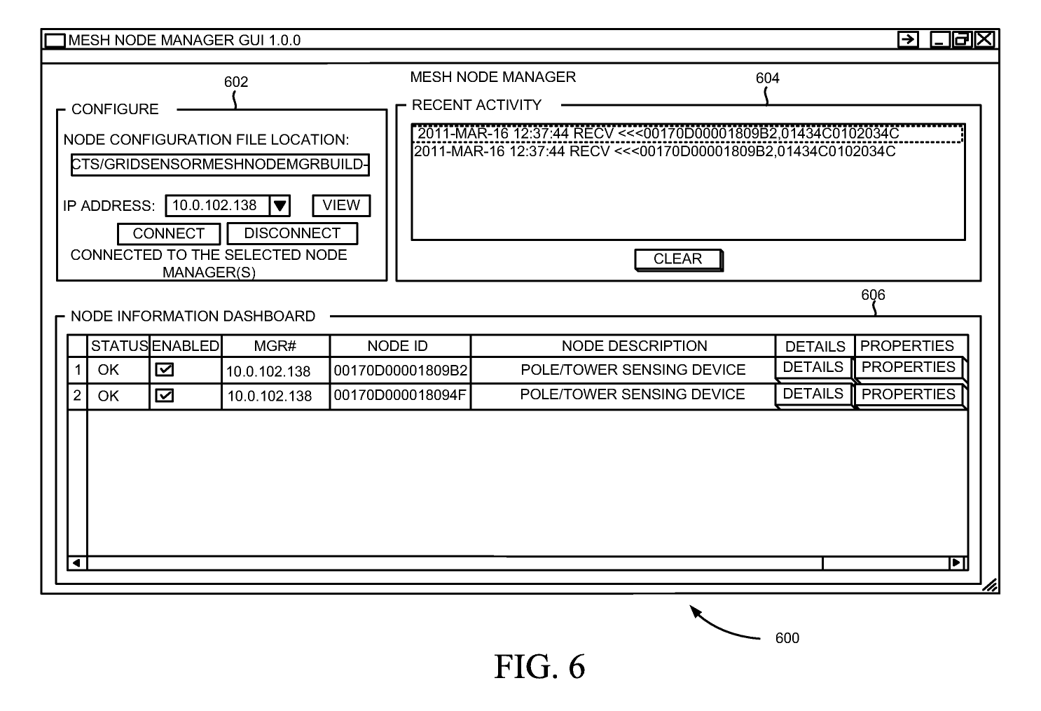

Referring now to FIG. 6, an exemplary screenshot 600 of an initial user-interface (UI) screen displayed on the display device 106 during operation of the utility and/or telecommunication networks 100 of FIG. 1 is illustrated. In one embodiment, the utility and network management module 104 in the remote monitoring server 102, shown in FIG. 1, enables a user to configure the nodes 112A-N, shown in FIG. 1, via the initial UI screen. The configuration of the nodes 112A-N include connecting one or more of the nodes 112A-N to the remote monitoring server 102, disabling one or more of the nodes 112A-N, managing one or more of the nodes 112A-N connected to the remote monitoring server 102, assigning a unique IP address to one or more of the nodes 112A-N connected to the remote monitoring server 102, upgrading firmware in one or more of the nodes 112A-N and the like. In one embodiment, as shown in FIG. 1, each of the nodes 112A-N is connected to the remote monitoring server 102.

In operation, the unique IP address assigned to each of the nodes 112A-N connected to the remote monitoring server 102 is used by the remote monitoring server 102 to connect and configure the nodes 112A-N in the utility and/or telecommunication networks 100, shown in FIG. 1. In an exemplary scenario, the IP address associated with each of the nodes 112A-N may change depending on the Internet protocol used.

As shown in FIG. 6, the screenshot 600 includes a configure field 602, a recent activity field 604 and a node information dashboard field 606. The configure field 602 includes a text box for displaying node configuration file location of an associated one of the nodes 112A-N and another text box for displaying an IP address of the associated one of the nodes 112A-N. The recent activity field 604 displays the recent activities of the associated one of the nodes 112A-N. Further, the recent activity field 604 also displays the date and time of occurrence of each activity in the associated one of the nodes 112A-N.

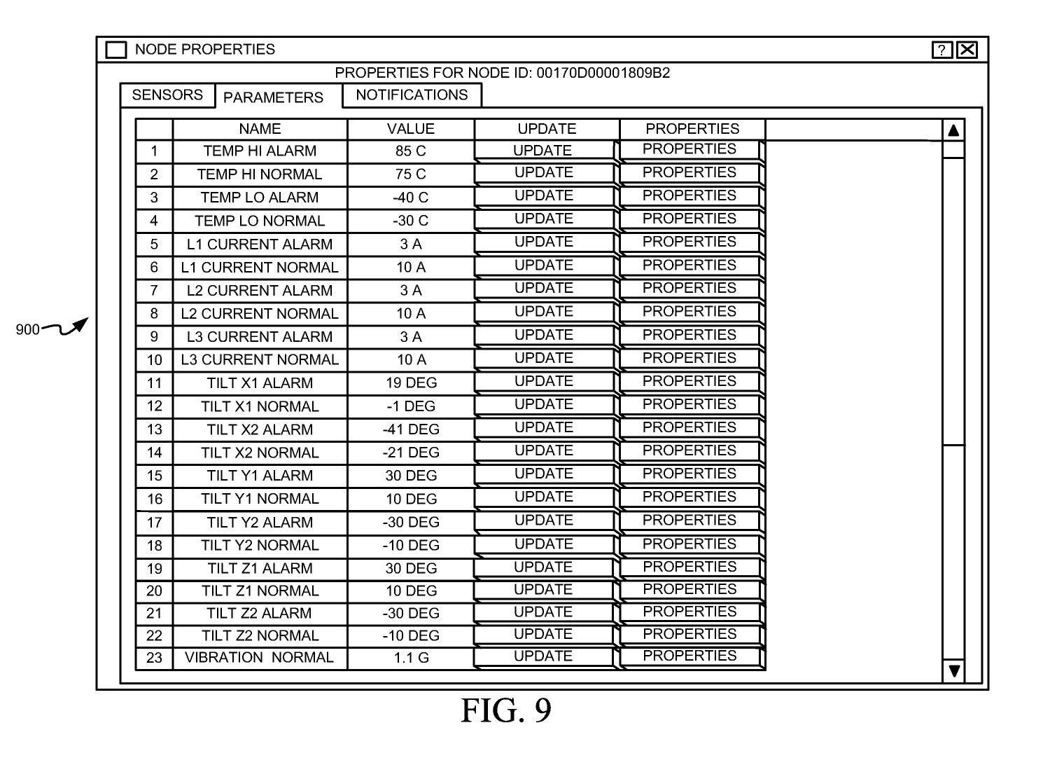

Further as shown in FIG. 6, the node information dashboard field 606 displays a table showing various columns, such as status, enabled, manager (MGR) #, node ID, node description, details and properties. The status column displays the status of the associated one of the nodes 112A-N. The MGR# column displays the IP address of the access point 108 connected to the associated one of the nodes 112A-N. The node ID column displays an ID of the associated one of the nodes 112A-N. In one embodiment, each of the nodes 112A-N is associated with a unique ID which does not change based on the Internet protocol used. The node description column displays the description of the associated one of the nodes 112A-N. The details column includes command buttons which when selected by a user displays more details regarding the associated one of the nodes 112A-N. The properties column also includes command buttons which when selected by the user displays properties of the associated one of the nodes 112A-N. This is explained in more detail with reference to FIGS. 8 and 9.

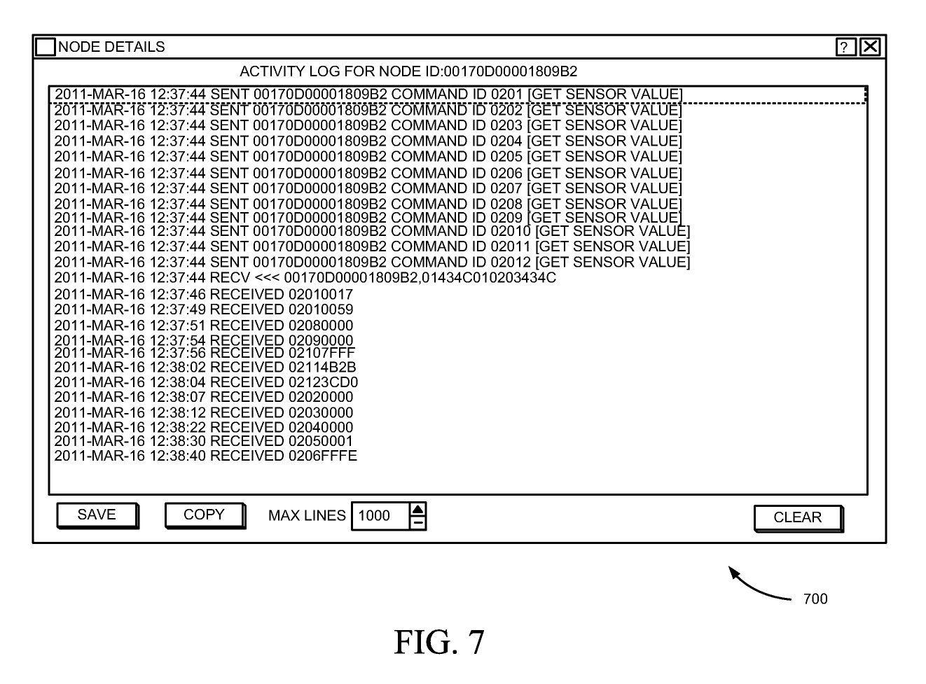

Referring now to FIG. 7, an exemplary screenshot 700, displayed on the display device 106, shows an activity log of one of the nodes 112A-N, during operation of the utility and/or telecommunication network 100 of FIG. 1 is illustrated. Particularly, FIG. 7 illustrates the screenshot 700 of the activity log associated with one of the nodes 112A-N, shown in FIG. 1, with a node ID 00170D0000180B2. In one embodiment, a user can send commands to the associated one of the nodes 112A-N, using the remote monitoring server 102, to obtain current sensor values of one or more sensors in the associated one of the nodes 112A-N, shown in FIG. 1. In response to the commands, the associated one of the nodes 112A-N sends the requested sensor values to the remote monitoring server 102, shown in FIG. 1. As shown in FIG. 7, the activity log displays a list of activities, such as sending commands to the associated one of the nodes 112A-N from the remote monitoring server 102 and receiving requested sensor values from the associated one of the nodes 112A-N.

Referring now to FIG. 8, an exemplary screenshot 800, displayed on the display device 106, shows current sensor values associated with one of the poles/towers 110A-N as sensed by the sensors in the associated one of the nodes 112A-N, during operation of the utility and/or telecommunication network 100 of FIG. 1. Particularly, FIG. 8 illustrates the current sensor values as sensed by the sensors in the associated one of the nodes 112A-N with the node ID 00170D0000180B2. The screenshot 800 may be displayed on the display device 106, shown in FIG. 1, when a command button labeled properties associated with one of the nodes 112A-N with the node ID 00170D0000180B2, in the screenshot 600, shown in FIG. 6, is selected by a user. As shown in FIG. 8, each row includes the current value as sensed by one of the sensors in the associated one of the nodes 112A-N. For example, the first row includes the temperature value as sensed by the temperature sensor 202, in the associated one of the nodes 112A-N, shown in FIG. 1.

Referring now to FIG. 9, an exemplary screenshot 900, displayed on the display device 106, shows parameter values associated with sensors in one of the nodes 112A-N during operation of the utility and/or telecommunication network 100 of FIG. 1. Particularly, FIG. 9 illustrates the user configurable threshold values associated with one of the nodes 112A-N with the node ID 00170D0000180B2. The screenshot 900 may be displayed on the display device 106, shown in FIG. 1, when a command button labeled properties associated with one of the nodes 112A-N with the node ID 00170D0000180B2, in the screenshot 600, shown in FIG. 6, is selected by a user. As shown in FIG. 9, each row includes a threshold value associated with a parameter. For example, rows 1 to 4 in the table in the screenshot 900 include the threshold values associated with the temperature sensor 202 in the associated one of the nodes 112A-N, shown in FIG. 1. As shown in FIG. 9, the first row includes a threshold value associated with a temperature high (HI) alarm parameter. Further as shown in FIG. 9, the second row includes a threshold value associated with a temperature HI normal parameter. Furthermore as shown in FIG. 9, the third row includes a threshold value associated with a temperature low (LO) alarm parameter. In addition as shown in FIG. 9, the fourth row includes a threshold value associated with a temperature LO normal parameter. Based on the threshold values associated with each of the parameters, shown in the screenshot 900, the remote monitoring server 102, shown in FIG. 1, determines the status of the associated one of the poles/towers 110A-N, shown in FIG. 1.

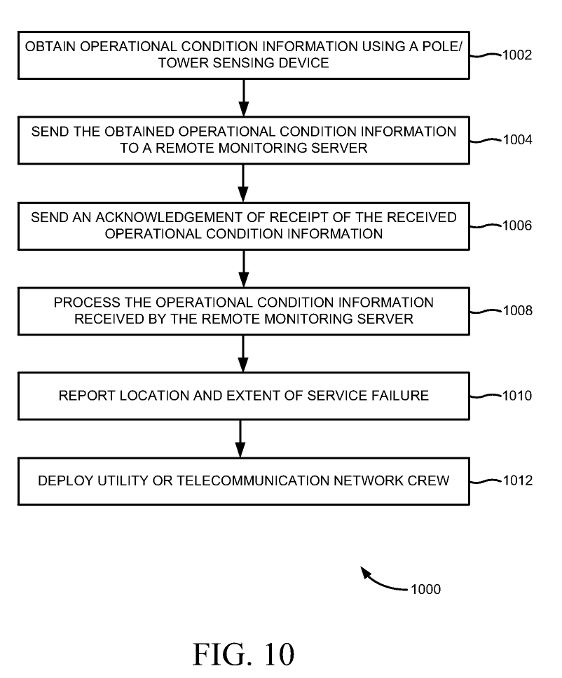

Referring now to FIG. 10, a flow diagram 1000 illustrates a method for automatic detection and reporting of location and extent of service failure in utility and/or telecommunication networks, according to an embodiment of the invention. At block 1002, operational condition information of each utility pole/tower or telecommunication pole/tower is obtained by using a pole/tower sensing device disposed to monitor operational conditions at each utility pole/tower or telecommunication pole/tower in the respective utility or telecommunication networks. The operational condition information is gathered by waking up the pole/tower sensing device located at each utility pole/tower or telecommunication pole/tower upon detecting a change in the operational condition. This is explained in more detail with reference to FIG. 3. Further, the pole/tower sensing device is provided power by scavenging energy from sources, such as solar energy, wind energy, EMF and the like.

In one embodiment, a temperature substantially in and around each utility pole/tower or telecommunication pole/tower is obtained using a temperature sensor in the pole/tower sensing device. Further in the embodiment, location information of each utility pole/tower or telecommunication pole/tower is obtained using a global positioning system (GPS) tracker in the pole/tower sensing device. Furthermore, accuracy of the location information obtained from the GPS tracker is ensured using a GIS system. In addition, the obtained location information is displayed on the form of a map using the GIS system.

Moreover in this embodiment, position information of each utility pole/tower or telecommunication pole/tower is obtained using an accelerometer in the pole/tower sensing device. In addition in this embodiment, any vibration of each utility pole/tower or telecommunication pole/tower is sensed using the accelerometer in the pole/tower sensing device. Also in this embodiment, EMF substantially around each utility pole/tower or telecommunication pole/tower is sensed to measure the presence or absence of current flow using an EMF sensor in the pole/tower sensing device.

In addition in this embodiment, it is determining whether each of the sensed temperature, position, vibration, and EMF values are substantially above, equal to or below an associated threshold value for each utility pole/tower or telecommunication pole/tower by the pole/tower sensing device. If any of the obtained operational condition information is above the associated threshold value, then at block 1004, the obtained operational condition information of each utility pole/tower or telecommunication pole/tower is sent to a remote monitoring server via a communication network by the associated pole/tower sensing device. Exemplary communication network includes a wireless communication network, a satellite communication network, a cellular communication network, a radio communication network, a 2 way pager communication network, a cell/satellite modem and an Ethernet network. Further, the operational condition information is sent along with a unique ID associated with each utility pole/tower or telecommunication pole/tower based on associated monitored operational conditions to the remote monitoring server by the pole/tower sensing device.

At block 1006, an acknowledgement of receipt of the received operational condition information from a respective pole/tower sensing device is sent by the remote monitoring server upon receiving the operational condition information from each associated pole/tower sensing device. At block 1008, the operational condition information received from each utility pole/tower or telecommunication pole/tower is processed by the remote monitoring server. At block 1010, location and extent of service failure in the utility or telecommunication networks is reported based on the outcome of processing the operational condition information by the remote monitoring server. At block 1012, utility or telecommunication network crew is deployed to the reported location to restore the service.

Referring now to FIG. 11, another flow diagram 1100 of a method for automatic detection and reporting of location and extent of service failure in utility and/or telecommunication networks, such as those shown in FIG. 1 is illustrated, according to an embodiment of the invention. At block 1102, a pole/tower sensing device wakes up and obtains operational condition information of an associated pole/tower. At block 1104, a check is made to determine whether a temperature associated with the pole/tower is greater than an associated threshold value. If the temperature of the pole/tower is greater than the associated threshold value, then at block 1106, a “fire alarm” notification is sent by the pole/tower sensing device to the remote monitoring server. At block 1104, if the temperature of the pole/tower is not greater than the associated threshold value, then the steps in block 1108 is performed. At block 1108, a motion is detected in the pole/tower.

At block 1110, a check is made to determine whether the difference between the new position of the pole/tower and the old position of the pole/tower is reportable. This is explained in more detail with reference to FIG. 2. If the difference between the new position of the pole/tower and the old position of the pole/tower is not reportable, then a check is made to determine whether current is not flowing in the pole/tower, at block 1112. If current is flowing, then the process is stopped at block 1116. If current is not flowing, then a “power line snapped” notification is sent to the remote monitoring server, at block 1114.

Referring back to the block 1110, if the difference between the new position of the pole/tower and the old position of the pole/tower is reportable, then a check is made to determine whether current is not flowing in the pole/tower, at block 1118. If current is flowing, then a “power line down” notification is sent to the remote monitoring server, at block 1120. At block 1122, the process is stopped. At block 1118, if current is not flowing, then a “power-out” notification is sent to the remote monitoring server, at block 1124. At block 1126, the process is stopped.

Referring now to FIG. 12, yet another flow diagram 1200 of a method for automatic detection and reporting of location and extent of service failure in utility and/or telecommunication networks, such as those shown in FIG. 1 is illustrated, according to an embodiment of the invention. At block 1202, a pole/tower sensing device wakes up and obtains operational condition information of an associated pole/tower. At block 1204, a check is made to determine whether a temperature associated with the pole/tower is greater than an associated threshold value. If the temperature of the pole/tower is greater than the associated threshold value, then at block 1206, a “fire alarm” notification is sent by the pole/tower sensing device to the remote monitoring server. At block 1204, if the temperature of the pole/tower is not greater than the associated threshold value, then the steps in block 1208 is performed. At block 1208, a motion is detected in the pole/tower.

At block 1110, a check is made to determine whether the difference between the new position of the pole/tower and the old position of the pole/tower is reportable. This is explained in more detail with reference to FIG. 2. If the difference between the new position of the pole/tower and the old position of the pole/tower is not reportable, the process is stopped at block 1212. If the difference between the new position of the pole/tower and the old position of the pole/tower is reportable, then a check is made to determine whether current is not flowing in the pole/tower. If current is flowing, then the process is stopped at block 1216. If current is not flowing, then a “power line snapped” notification is sent by the pole/tower sensing device to the remote monitoring server, at block 1218. At block 1220, the process is stopped.

In various embodiments, the systems and methods described in FIGS. 1 through 12 eliminate manual reporting of power or telecommunication outage in utility and/or telecommunication network. Further the systems and methods described in FIGS. 1 through 12 enable public utilities and telecommunications service providers to obtain a detailed view of the condition of the utility and telecommunication network, respectively, from a central location.

Although the present embodiments have been described with reference to specific example embodiments, it will be evident that various modifications and changes may be made to these embodiments without departing from the broader scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structures and methods may be embodied using transistors, logic gates, and electrical circuits, such as an application specific integrated circuit.

What is claimed is:

1. A method for automatic detection and reporting of location and extent of service failure in utility and telecommunication networks, comprising:
obtaining operational condition information of each utility pole/tower or telecommunication pole/tower by using a pole/tower sensing device disposed to monitor operational conditions at each utility pole/tower or telecommunication pole/tower in the respective utility or telecommunication networks;
sending the obtained operational condition information of each utility pole/tower or telecommunication pole/tower to a remote monitoring server via a communication network by the associated pole/tower sensing device;
processing the operational condition information received from each utility pole/tower or telecommunication pole/tower by the remote monitoring server; and
reporting location and extent of service failure in the utility or telecommunication networks based on the outcome of processing the operational condition information by the remote monitoring server.

2. The method of claim 1, further comprising:
deploying utility or telecommunication network crew to the reported location to restore the service.

3. The method of claim 1, wherein obtaining the operational condition information of each utility pole/tower or telecommunication pole/tower by using the pole/tower sensing device disposed to monitor the operational conditions at each utility pole/tower or telecommunication pole/tower in the respective utility or telecommunication networks comprises:
obtaining a temperature substantially in and around each utility pole/tower or telecommunication pole/tower using a temperature sensor in the pole/tower sensing device;
obtaining location information of each utility pole/tower or telecommunication pole/tower using a global positioning system (GPS) tracker in the pole/tower sensing device;
obtaining position information of each utility pole/tower or telecommunication pole/tower using an accelerometer in the pole/tower sensing device;
sensing any vibration of each utility pole/tower or telecommunication pole/tower using the accelerometer in the pole/tower sensing device; and
sensing electromagnetic field (EMF) substantially around each utility pole/tower or telecommunication pole/tower to sense the presence or absence of current flow using an EMF sensor in the pole/tower sensing device.

4. The method of claim 3, wherein obtaining the location information of each utility pole/tower or telecommunication pole/tower using the GPS tracker in the pole/tower sensing device comprises:
obtaining the location information of each utility pole/tower or telecommunication pole/tower using the GPS tracker in the pole/tower sensing device;
ensuring accuracy of the location information obtained from the GPS tracker using a geographic information system (GIS) system; and
displaying the obtained location information in a map using the GIS system.

5. The method of claim 3, wherein sending the obtained operational condition information of each utility pole/tower or telecommunication pole/tower to the remote monitoring server via the communication network by the associated pole/tower sensing device comprises:
sending the operational condition information of each utility pole/tower or telecommunication pole/tower based on associated monitored operational conditions to the remote monitoring server via the communication network selected from the group consisting of a wireless communication network, a satellite communication network, a cellular communication network, a radio communication network, a 2 way pager communication network, a cell/satellite modem and an Ethernet network.

6. The method of claim 5, wherein sending the operational condition information of each utility pole/tower or telecommunication pole/tower based on associated monitored operational conditions to the remote monitoring server via the communication network comprises:
determining whether each of the sensed temperature, position, vibration, and EMF values are substantially above, equal to or below an associated threshold value for each utility pole/tower or telecommunication pole/tower by the pole/tower sensing device; and
sending the operational condition information of each utility pole/tower or telecommunication pole/tower in the utility or telecommunication networks to the remote monitoring server via the communication network by the pole/tower sensing device based on the outcome of the determination.

7. The method of claim 1, wherein sending the operational condition information of each utility pole/tower or telecommunication pole/tower based on associated monitored operational conditions to the remote monitoring server by the pole/tower sensing device comprises:
sending the operational condition information along with a unique identification (ID) associated with each utility pole/tower or telecommunication pole/tower based on associated monitored operational conditions to the remote monitoring server by the pole/tower sensing device.

8. The method of claim 1, wherein monitoring the operational conditions of each utility pole/tower or telecommunication pole/tower using the pole/tower sensing device disposed at each utility pole/tower or telecommunication pole/tower in the respective utility or telecommunication networks, comprises:
waking up and gathering operational condition information by the pole/tower sensing device located at each utility pole/tower or telecommunication pole/tower upon detecting a change in the operational condition.

9. The method of claim 1, further comprising:
sending acknowledgement of receipt of the received operational condition information from a respective pole/tower sensing device by the remote monitoring server upon receiving the operational condition information from each associated pole/tower sensing device.

10. The method of claim 1, further comprising:
providing power to the pole/tower sensing device by scavenging energy from sources selected from the group consisting of solar energy, wind energy and EMF.

11. A system for automatic detection and reporting of location and extent of service failure in utility and telecommunication networks, comprising:
a plurality of utility poles/towers and/or telecommunication poles/towers;
a pole/tower sensing device disposed on each of the plurality of utility poles/towers and/or telecommunication poles/towers to monitor operational conditions at each utility pole/tower or telecommunication pole/tower in the respective utility or telecommunication networks; and
a remote monitoring server coupled to each pole/tower sensing device via a communication network, wherein the pole/tower sensing device obtains operational condition information of each utility pole/tower or telecommunication pole/tower, wherein the pole/tower sensing device sends the obtained operational condition information of each utility pole/tower or telecommunication pole/tower to the remote monitoring server via the communication network, wherein the remote monitoring server processes the operational condition information received from each utility pole/tower or telecommunication pole/tower, and wherein the remote monitoring server reports location and extent of service failure in the utility or telecommunication networks based on the outcome of processing the operational condition information for deploying utility and/or telecommunication network crews to the reported location to restore the service.

12. The system of claim 11, wherein the pole/tower sensing devices comprises:
a power source and an associated power conditioning device;
a processor coupled to the power source via the power conditioning device;
a communication device coupled to the processor and configured to communicate with the remote monitoring server via the communication network;
a temperature sensor coupled to the processor via an interface card for obtaining a temperature substantially in and around each utility pole/tower or telecommunication pole/tower;
a GPS tracker coupled to the processor via the interface card for obtaining location information of each utility pole/tower or telecommunication pole/tower;
an accelerometer coupled to the processor via the interface card for obtaining position information and for sensing any vibration of each utility pole/tower or telecommunication pole/tower; and
an electromagnetic field (EMF) sensor coupled to the processor via the interface card to sense the presence or absence of current flow in and around each utility pole/tower or telecommunication pole/tower.

13. The system of claim 12, wherein the remote monitoring server comprises:
a utility and network management module, wherein the utility and network management module ensures accuracy of the location information obtained from the GPS tracker using a geographic information system (GIS) system, and wherein the utility and network management module displays the obtained location information in a map using the GIS system on a display device coupled to the remote monitoring server.

14. The system of claim 13, wherein the communication network is selected from the group consisting of a wireless communication network, a satellite communication network, a cellular communication network, a radio communication network, a 2 way pager communication network, a cell/satellite modem and an Ethernet network.

15. The system of claim 13, wherein the pole/tower sensing device disposed at each utility and telecommunication network determines whether each of the sensed temperature, position, vibration, and EMF values are substantially above, equal to or below an associated threshold value for each utility pole/tower or telecommunication pole/tower by the pole/tower sensing device, and wherein the pole/tower sensing device sends the operational condition information of each utility pole/tower or telecommunication pole/tower in the utility or telecommunication networks to the remote monitoring server via the communication network based on the outcome of the determination.

16. The system of claim 15, wherein each pole/tower sensing device sends the operational condition information along with a unique identification (ID) associated with each utility pole/tower or telecommunication pole/tower based on the outcome of the determination to the remote monitoring server.

17. The system of claim 16, wherein the pole/tower sensing device disposed at each utility pole/tower or telecommunication pole/tower wakes up and gathers operational condition information upon detecting a change in the operational condition.

18. The system of claim 17, wherein the utility and network management module residing in the remote monitoring server sends an acknowledgement of receipt of the received operational condition information from a respective pole/tower sensing device upon receiving the operational condition information from each associated pole/tower sensing device.

19. The system of claim 11, wherein the pole/tower sensing device disposed on each utility pole/tower or telecommunication pole/tower is configured to scavenge energy from surrounding environment from sources selected from the group consisting of solar energy, wind energy and EMF.

20. A pole/tower sensing device for automatic detection and reporting of location and extent of service failure in utility and telecommunication networks, wherein the pole/tower sensing device is configured to couple to each utility pole/tower or telecommunication pole/tower in the utility and telecommunication networks via a communication network, and wherein each pole/tower sensing device is further configured to monitor operational conditions at each utility pole/tower or telecommunication pole/tower in the respective utility or telecommunication networks, comprising:
a power source and an associated power conditioning device;
a processor coupled to the power source via the power conditioning device;
a communication device coupled to the processor and configured to communicate with a remote monitoring server via a communication network; and
a plurality of sensors coupled to the processor via an interface card for obtaining operational condition information of the associated utility pole/tower or telecommunication pole/tower, wherein the pole/tower sensing device sends the obtained operational condition information of each utility pole/tower or telecommunication pole/tower to the remote monitoring server via the communication network for processing the operational condition information received from each utility pole/tower or telecommunication pole/tower and reporting location and extent of service failure in the utility or telecommunication networks based on the outcome of processing the operational condition information for deploying utility and/or telecommunication network crews to the reported location to restore the service.

21. The pole/tower sensing device of claim 20, wherein the plurality of sensors comprise:
a temperature sensor coupled to the processor via the interface card for obtaining a temperature substantially in and around each utility pole/tower or telecommunication pole/tower;
a global positioning system (GPS) tracker coupled to the processor via the interface card for obtaining location information of each utility pole/tower or telecommunication pole/tower;
an accelerometer coupled to the processor via the interface card for obtaining position information and for sensing any vibration of each utility pole/tower or telecommunication; and
an electromagnetic field (EMF) sensor coupled to the processor via the interface card to sense the presence or absence of current flow in and around each utility pole/tower or telecommunication pole/tower.

22. The pole/tower sensing device of claim 21, wherein the processor determines whether each of the sensed temperature, position, vibration, and EMF values are substantially above, equal to or below an associated threshold value for each utility pole/tower or telecommunication pole/tower, and wherein the processor sends the operational condition information of each utility pole/tower or telecommunication pole/tower in the utility or telecommunication networks to the remote monitoring server via the communication network based on the outcome of the determination via the communication device.

23. The pole/tower sensing device of claim 22, wherein the processor wakes up and gathers operational condition information upon detecting a change in the operational condition and sends the gathered operational condition information to the remote monitoring server.

24. The pole/tower sensing device of claim 23, wherein the processor via the communication device is configured to receive an acknowledgement of receipt of the received operational condition information by the remote monitoring server.
